(19) United States
(12) Patent Application Publication
(10) Pub. No.: US 2020/0091749 A1
(43) Pub. Date: Mar. 19, 2020

(54) PORTABLE POWER SOURCE

(71) Applicant: Shenzhen IDMiX innovative Products Co., Ltd., Shenzhen (CN)

(72) Inventor: Jing WEN, Shenzhen (CN)

(21) Appl. No.: 16/226,659

(22) Filed: Dec. 20, 2018

(30) Foreign Application Priority Data
Sep. 14, 2018 (CN) 201821514206.6

(51) Int. Cl. H02J 7/00; H01R 31/06; H01R 13/66; H01R 13/72

(52) U.S. Cl. CPC H02J 7/0054; H01R 31/06; H01R 13/66; H02J 2007/0062; H02J 7/0042; H01R 13/72; H02J 7/0027

(57) ABSTRACT

A portable power source includes a body and a charging member connected to the body. The charging member includes a connecting strip with one end thereof connecting to the body, and a plug formed on an opposite end of the connecting strip. The connecting strip is flexible so that it can be used in a bending state or a stretching state. Such structure of the present portable power source is convenient to be charged.

### CROSS-REFERENCE TO RELATED APPLICATION

This application claims the priority benefit of CN application serial no. 201821514206.6, filed Sep. 14, 2018. The entirety of the above-mentioned patent application is hereby incorporated by reference herein and made a part of specification.

### BACKGROUND

### 1. Technical Field

The present disclosure generally relates to portable charging devices field, and especially relates to a portable power source.

### 2. Description of Related Art

A portable power source is a kind of portable changer, integrated with power supply and charging functions, that it can charge all kinds of electrical devices, such as mobile phones, tablets and other digital devices, anytime and anywhere, which is convenient to people's travel.

At present, there are roughly two types of portable power sources in the market: one type is a built-in charging plug type and the other type is an external-connection charging plug type. The type of portable power source with a built-in charging plug is provided that a plug is integrated with a body of the portable power source, so that it is more convenient to carry and use compared with the portable power source with an external-connection charging plug. A conventional charging plug generally includes a connecting post and a pin. For the portability of the portable power source, the external-connection charging plug is rotatably connected to the body of the portable power source via a connecting portion, and the body includes a receiving slot for receiving the external-connection charging plug therein. The portable power source can be charged by turning the pin of the charging plug out of the receiving slot and then inserting it into the socket. However, the length of the external-connection charging plug is limited because the pin is arranged adjacent to the body. In this way, the portable power source can't be charged when the socket is set in a narrow space that the body can't be inserted therein, thereby such portable power source has a certain limitations to use.

### SUMMARY

The technical problems to be solved: in view of the shortcomings of the related art, the present disclosure relates to a portable power source which can reduce the charging limitations of the portable power source due to its limited length and be used more convenient.

The technical solution adopted for solving technical problems of the present disclosure is:

a portable power source includes a body and a charging member connected to the body. The charging member includes a connecting strip and a plug, an end of the connecting strip connected to the body and the plug formed on an, opposite end of the connecting strip. The connecting strip is flexible so that it can be used in a bending state or a stretching state.

Wherein the connecting strip includes a flexible section and a mounting section, a portion of the flexible section connected to the body and an opposite portion of the flexible section connected to the mounting section, the plug formed on the mounting section, the flexible section and the mounting section integrated with each other by flexible material.

Wherein the mounting section is thickened with respect to the flexible section along a direction perpendicular to an extension direction of the flexible section.

Wherein the body includes a first receiving recess matched with the mounting section.

Wherein the flexible section includes at least one thinning groove arranged along the extension direction of the flexible section.

Wherein the flexible section is tightly fixed with the body.

Wherein the body includes a receptacle for inserting the plug therein.

Wherein the receptacle and a fixing portion of the connecting strip connected to the body are respectively formed at two opposite sides of the body.

Wherein the connecting strip is in the bending state when the plug is inserted into the receptacle, and a gap is formed between a bending portion of the connecting strip and the body.

Wherein the body further includes a bar arranged in the receptacle for inserting the plug therein by an interference fit way.

The present disclosure provides the advantages as below.

The structure of the present disclosure includes a body and a charging member connected to the body. The charging member includes a connecting strip and a plug, an end of the connecting strip connected to the body and the plug formed on an opposite end of the connecting strip. The connecting strip is flexible so that it can be used in t a bending state or a stretching state. It can be understood that the connecting strip can be bent or stretched according to an actual situation to adapt to different service environments when the portable power source is needed to charge. Comparing with a conventional portable power source, the present structure of the portable power source can still be charged in more complex environments by changing connection states of the connecting strip, which can reduce charging limitations and be used more convenient.

### BRIEF DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of the portable power source in accordance with an exemplary embodiment.

FIG. 2 is similar to FIG. 1, but shown from another view.

FIG. 3 is a schematic view of the portable power source of FIG. 1, shown a charging member of the portable power source unfolded.

FIG. 4 is an internal schematic view of the portable power source of FIG. 1.

FIG. 5 is an enlarged schematic view of circle A of the portable power source of FIG. 1.

FIG. 6 is a schematic view of the portable power source of FIG. 1, but shown a transmission line unfolded thereof.

FIG. 7 is a schematic view of an adapter and the portable power source of FIG. 1, shown from a view of the adapter assembling to a body of the portable power source.

The element labels according to the exemplary embodiment of the present disclosure shown as below:

body 1, first receiving recess 11, receptacle 12, bar 13, second receiving recess 14, transmission line 15, charging interface 151, slot 16, first fixing groove 17, third receiving recess 18, second fixing groove 19, charging member 2, connecting strip 21, fixing portion 21a, bending portion 21b, clasp 21c, flexible section 211, mounting section 212, thinning groove 213, plug 22, adapter 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. The disclosure is illustrated by way of example and not by way of limitation in the figures of the accompanying drawings, in which like reference numerals indicate similar elements.

In the description of the present disclosure, it needs to be explained that all the directional indicators (such as the terms: “upper”, “below”, “left”, “right”, “front”, “back” . . . ), are shown in the specification of the present disclosure. The indicated orientation or position of the terms shown in the detailed description is based on the orientation or position shown in the figures of the accompanying drawings of the present disclosure, which is only to easily simplify the description of the present disclosure, but not indicated that the devices or elements of the present disclosure should have a particular orientation or should be designed and operated in a particular orientation. So the terms illustrated in the detail description are not by way of the limitation of the present disclosure.

Furthermore, in the description of the present disclosure, the terms such as “first” and “second” shown in the specification are only used to describe, but not indicated that the elements of the present disclosure is important or represented the amount of the elements. That is, the features limited by the terms of “first” and “second” may explicitly or implicitly include one or more features. In addition, the terms such as “and/or” shown in the specification are meant to include three side-by-side solutions. “A and/or B” taken as an example, it includes solution A, or solution B, or both solution A and solution B. Meanwhile, the technical solutions between some exemplary embodiments can be combined with each other, but it can be implemented my on the basis of those of ordinary skill in the art. When the combination of the technical solutions contradicts each, other or cannot be implemented, it should be considered that the combination of such technical solution does not exist and is not within the scope of the requirements of the present disclosure.

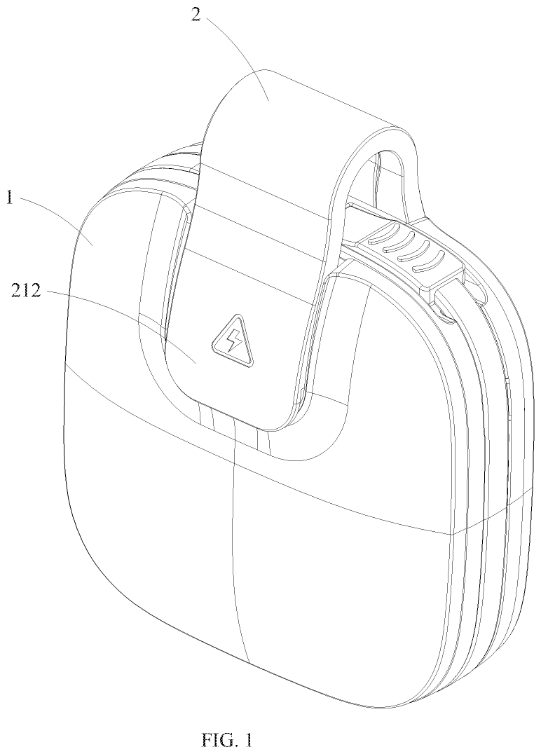

Referring to FIGS. 1-3, a portable power source in accordance with an exemplary embodiment is provided. The portable power source includes a body 1 and a charging member 2 connected to the body 1. The charging member 2 includes a connecting strip 21 and a plug 22. An end of the connecting strip 21 is connected to the body 21 and the plug 22 is formed on an opposite end of the connecting strip 21. The connecting strip 21 is flexible so that it can be used in a bending state or a stretching state.

It should be noted that each of the bending state and e stretching state described in the present disclosure is a relative state. With a straight line as the reference, the stretching state of the connecting strip 21 described in the specification is: in this state, the connecting strip 21 can be approximately considered to be a straight line rather than a collinear arrangement with the body 1, and an angle between the connecting strip 21 and the body 1 can't affect to use the connecting strip 21. Similarly, it can be seen that the bending state of the connecting strip 21 is only based on the change of its own shape rather than being relate to the body 1. The bending state of the connecting strip 21 shown in the present disclosure is relative to the stretching state. The connecting strip 21 is bent at a certain position of itself without limiting its bending angle. The connecting strip 21 can be, regarded as in the betiding state as long as it can't maintain on the stretching state.

At the same time, in order to charge the body 1, electrical connection between the plug 22 and the body 1 can be obtained by the connecting strip 21. Specifically, copper wires, aluminum wires, silver wires and other wires can be set in the connecting strip 21 to electrically connect to the plug 22 and the body respectively. How to realize the electrical connection between plug 22 and the body 1 is a very mature and conventional technical means, so it doesn't describe here. Similarly, the structure and functions of the body 1 is also a very mature and conventional technical means, thereby it can't be described here.

The structure of the present disclosure includes the body 1 and the charging member 2 connected to the body 1. The charging member 2 includes the connecting strip 21 and the plug 22, an end of the connecting strip 21 connected to the body 1 and the plug 22 formed on an opposite end of the connecting strip 21. The connecting strip 21 is flexible so that it can be used in a bending state or a stretching state. It can be understood that the connecting strip can be bent or stretched according to an actual situation to adapt to different service environments when the portable power source is needed to charge. comparing with a conventional portable power source, the present structure of the portable power source can still be charged in more complex environments by changing connection states of the connecting strip, which can reduce the charging limitations and be used more convenient.

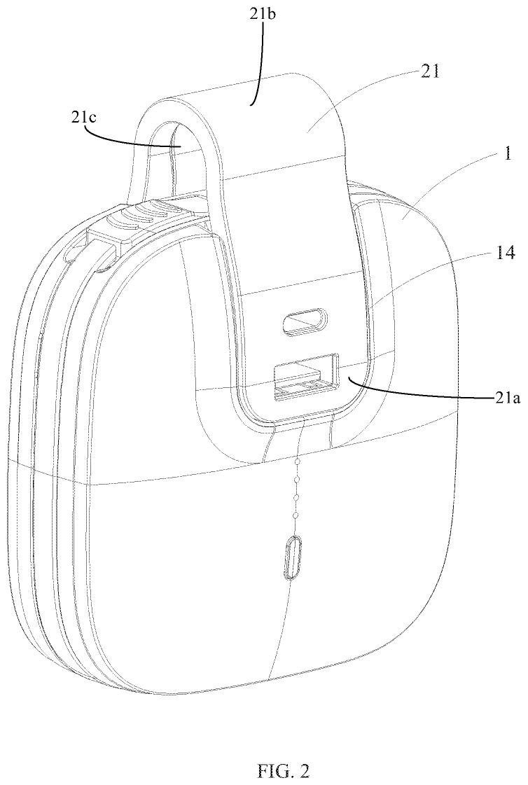

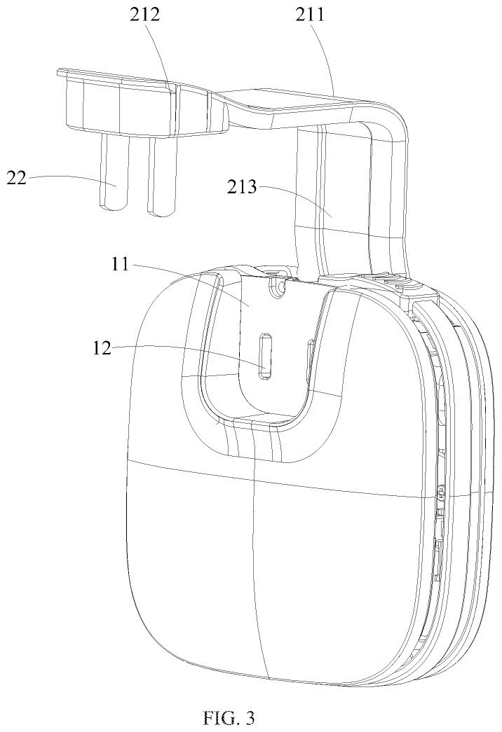

Furthermore, referring to FIG. 2 and FIG. 3, in an exemplary embodiment of the present disclosure, the connecting strip 21 includes a flexible section 211 and a mounting section 212. A portion of the flexible section 211 is connected to the body 1 and an opposite portion of the flexible section 211 is connected to the mounting section 212, and the plug 22 is formed on the mounting. section 212. The flexible section 211 and the mounting section 212 are integrated with each other by flexible material. That is to say, in an exemplary embodiment of the present disclosure, the connecting strip 21 is made of flexible material. Specifically, in an exemplary embodiment of the present disclosure, the flexible section 211 and the mounting section 212 are formed by injection molding of TPE soft rubber (Thermoplastic Elastomer, a Thermoplastic elastic material). The TPE material has the advantages of high strength, high resilience, good plasticity, easy coloring and environmental protection, non-toxic and pollution-free. So, the connecting strip 21 made of TPE material also has all the advantages shown above. In other exemplary embodiments of the present disclosure, the flexible section 211 and the mounting section 212 can also be made of other flexible materials such as silicone, rubber and thermoplastic resin. Through an integrated forming process, the manufacturing process of flexible section 211 and the mounting section 212 can be greatly simplified, and the production cost of the connecting strip 21 can also be effectively reduced. And then, the flexible section 211 and the mounting section 212 are made of the same material to reduce the manufacture materials, and then reduce the production cost of the connecting strip 21

It should be noted that, in other exemplary embodiments of the present disclosure, the flexible section 211 and the mounting section 212 isn't integrated with each other. Specifically, since the deformation of the connecting strip 21 is mainly provided by the flexible section 211, the flexible section 211 can be made of flexible materials such as TPE soft rubber, silicone and rubber mentioned above, and the mounting section 212 can be made of other insulation materials such as PP, PE, PVC and solid wood.

Furthermore, the flexible section 211 includes at least one thinning groove 213 arranged along an extension direction of the flexible section 211. Specifically, in an exemplary embodiment of the present disclosure, the flexible section 211 includes only one cuboid thinning groove 213 arranged on a side thereof facing the body 1.

The thinning groove 213 is formed on the flexible section 211 for thinning the flexible section 211. In this way, not only the flexible section 211 can be more easily deformed to easily use the connecting strip 21, but also the material of the flexible section 211 can be reduced to minimize the manufacturing cost of the connecting strip 21. In addition, in an exemplary embodiment of the present disclosure, the connecting strip 21 is made by an injection molding way so that the thinning groove 213 is provided to facilitate the flexible section 211 to demolding from the molding during forming the connecting strip 21.

It should be noted that, in other exemplary embodiments of the present disclosure, the flexible section 211 can include a plurality of thinning grooves 213, with a tri-prism shaped or a semi-cylindrical shaped, formed in parallel to each other. The extension direction of the flexible section 211 can be perpendicular or parallel to that of the flexible section 211.

Furthermore, comparing with removable connection, the flexible section 211 is tightly fixed with the body 1 to reduce connecting structures therebetween. In this way; the connecting strip 21 can't be separated from the body 1, thereby the span-life of the portable power source can be effectively improved, Of course, in other exemplary embodiments of the present disclosure, the flexible section 211 can be rotatably or slidably connected to the body 1.

Furthermore, the mounting section 212 is thickened with respect to the flexible section 211 along a direction perpendicular to the extension direction of the flexible section 211.

The plug 22 is arranged on the mounting section 212 with a more thickness configuration, Which can not only to provide enough space for installing the plug 22 and improve the installation stability of the plug 22, but also to reduce vibration and breakage of the plug 22 due to increase of service life/times. So, the span-life and safety of the portable power source can be improved.

Furthermore, referring to FIG. 3, the body 1 includes a first receiving recess 11 matched with the mounting section 212. Specifically, in an exemplary embodiment of the present disclosure, the first receiving recess 11 is provided to form a gap on the body 11 for facilitating to install the mounting section 212 on the body 1.

When the charging member 2 isn't used, the mounting section 212 is embedded in the first receiving recess 11 to conveniently receive and fold the connecting strip 21. At the same time, the mounting section 212 is made of flexible material so that the mounting section 212 can be installed on the first receiving recess 11 by an interference fit way to improve the stability between the mounting section 212 and the first receiving recess 11 and reduce the detachment possibility therebetween.

Furthermore, the body 1 includes a receptacle 12 for inserting the plug 22 therein. Specifically, in an exemplary embodiment of the present disclosure, the receptacle 12 is formed on a bottom wall of the first receiving recess 11.

The receptacle 12 is arranged on the body 1 so that the plug 22 can be inserted into pins of the receptacle 12 when the connecting strip 21 is folded. In this way, it can not only improve the connection stability of the plug 22 and the body 1 and reduce the trouble of frequent arrangement of the connecting strip 21, but also improve the integrity and portability of the portable power source and reduce the space occupied by the portable power source. Furthermore, the plug 22 is formed on the bottom wall of the first receiving recess 11 to fit with the characteristics of the mounting section 212, thereby the integrity, portability and appearance of the portable power source can be further improved to be conducive to the sale of the portable power source.

It should be noted that, in other exemplary embodiments of the present disclosure, the receptacle 12 can also be independently arranged from the first receiving recess 11, that is, the first receiving recess 11 and the receptacle 12 are simultaneously and respectively arranged on the body 1. In this way, the mounting section 212 can be inserted into the first receiving recess 11 to tightly fix with the plug 22, or the plug 22 can be inserted into the receptacle 12 to be fixed. It can be understood that, in other exemplary embodiments of the present disclosure, the body 1 can only include one of the first receiving recess 11 and the receptacle 12.

Furthermore, the receptacle 12 and a fixing portion 21a of the connecting strip 21 connected to the body 1 are respectively formed at two opposite sides of the body 11.

Comparing to an arrangement of the receptacle 12 and a fixing portion 21a of the connecting strip 21 connected to the body 1 is formed at a same side of the body 1, such arrangement mentioned above can allow the connecting strip 21 to bypass the body 1 when the plug 22 is fixed. In this way, the length of the connecting strip 21 can be effectively increased on the premise of controlling space occupied by the portable power source to adapt to more charging environments. In addition, in such arrangement, the deformation degree of the connecting strip 21 can be weakened to further improve its span-life.

Furthermore, referring to FIG. 2, the body 1 further includes a second receiving recess 14 for receiving the fixing portion 21a therein. Specifically, in an exemplary embodiment of the present disclosure, the first receiving recess 11 and the second receiving recess 14 are respectively formed on two opposite ends of the body 1.

The second receiving recess 14 is provided to increase the integrity=between the body 1 and the connecting strip 21 so that the portability and appearance of the portable power source can be further improved.

Furthermore, referring to FIG. 1. the connecting strip 21 is in the bending state when the plug 22 is inserted into the receptacle 12, and a gap is formed between a bending portion 21b of the connecting strip 21 and the body 1. Thus, the length of the connecting strip 21 can be effectively increased to make the portable power source adapt to more charging environments. Meanwhile, both the first receiving recess 11 and the receptacle 12 are provided to ensure the connection stability between the plug 22 and the body 1. The gap between the bending portion 21b and the body 1 is provided to form a clasp 21c thereof to conveniently apply force by users to carry the portable power source. The clasp 21c can also be used to fix the portable power source on some objects, such as backpacks, so as to improve its portability.

It should be noted that, in other exemplary embodiments of the present disclosure, when the plug 22 is inserted into the receptacle 12, the connecting strip 21 can also be attached to a surface of the body 1 to minimize the space occupied by the portable power source.

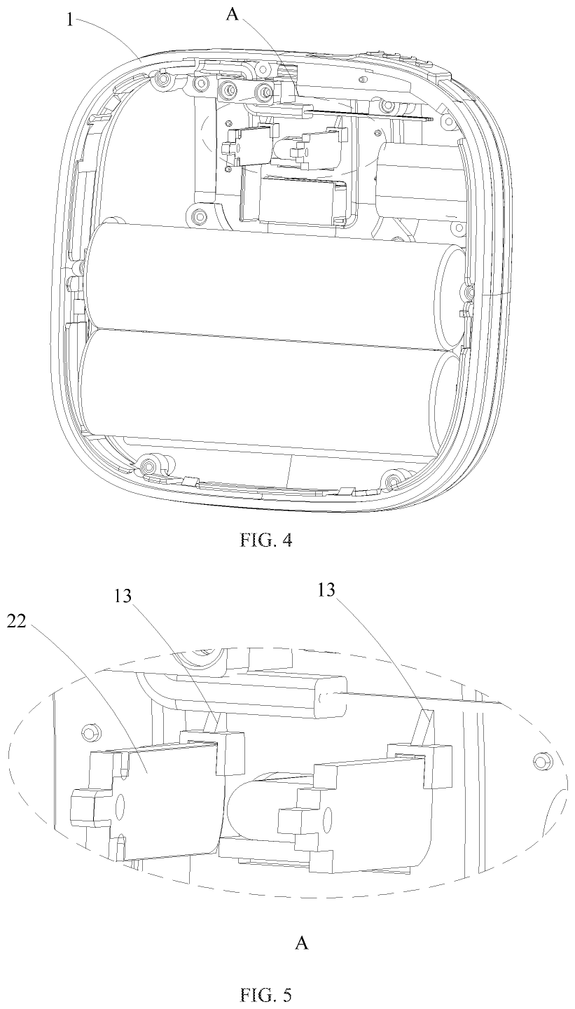

Furthermore, referring to FIG. 4 and FIG. 5, the body 1 further includes a bar 13 arranged on the receptacle 12 for inserting the plug 22 therein by an interference fit way.

The bar 13 is provided to further limit the position of the body 1 and the plug 22 so that the plug 22 can't be easily separated from the receptacle 12. Due to the interference fit engagement between the bar 13 and the plug 22, the connection stability between the plug 22 and the body 1 can be further improved by utilizing elastic force generated by the plug 22 after its deformation.

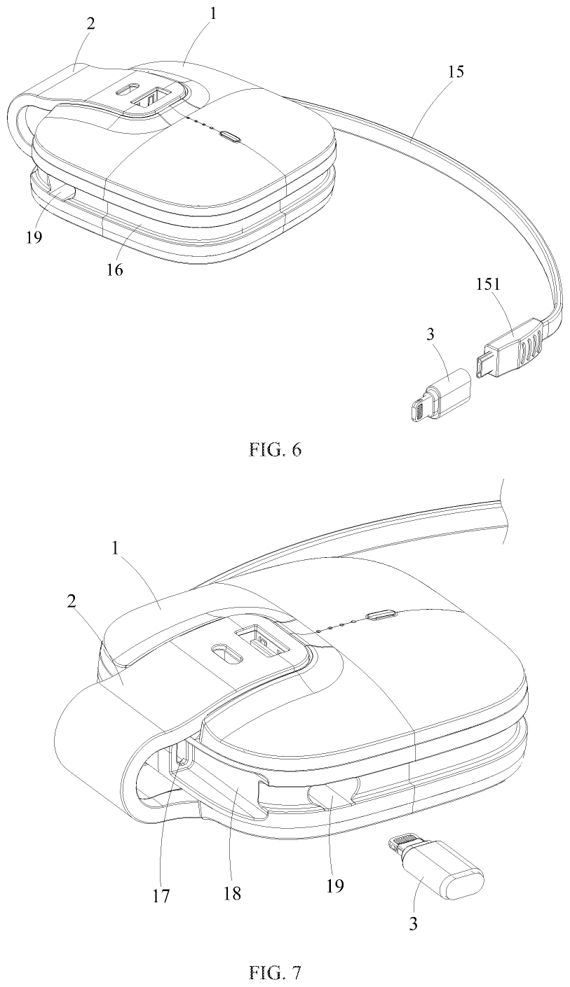

Furthermore, referring to FIG. 6, the body 1 further includes a transmission line 15. One end of the transmission line 15 is tightly fixed to the body 1 and a charging interface 151 is formed on the other end of the transmission line 15 for charging external electronic devices. Specifically, in an exemplary embodiment of the present disclosure, the transmission line 15 is also made of TPE soft rubber. The charging interface 151 can select from one of a Micro-B interface, a USB Type-C interface and a Lighting interface. In an exemplary embodiment of the present disclosure, the charging interface 151 is a Micro-B interface. The transmission line 15 is formed on the body 1 so that users don't need to carry extra charging lines, thereby improving the portability of the portable power source.

Furthermore, the body 1 further includes a slot 16 surrounded around the outer edge thereof for embedding the transmission line 15 therein by the interference fit way. In this way, the transmission line 15 can not only be received in the slot 16, but also the integrity of the portable power source can be improved to be carried by users.

Specifically, referring to FIG. 6 and FIG. 7, the charging interface 15 includes an inserting portion with a port, and a connecting portion connected the port with the transmission line 15.

The body 1 further includes a first fixing groove 17 for receiving the inserting portion of the charging interface 151. The first fixing groove 17 is provided to not only limit the position of the transmission line 15 and combine the transmission line 15 with the body 1 more closely, but also protect the charging interface 151 from being broken to further improve the span-life of the charging interface 151. Specifically, in an exemplary embodiment of the present disclosure, the first fixing groove 17 is formed on a side opposite to the side of the body 1 fixed with the transmission line 15. It should be noted that, in other exemplary embodiments of the present disclosure, the first fixing groove 17 can be arranged on other portions of the body 1.

Furthermore, the body 1 further includes a third receiving recess 18 matched with the connecting portion of the transmission line 15 to further improve the integrity of the portable power source and prevent the transmission line 15 from disengaging from the slot 16.

Furthermore, the portable power source further includes an adapter 3 which includes an input connected to the charging interface 15 and an output selected from one of a Micro-B interface, a USB Type-C interface and a Lighting interface. The type of the output is different from that of the charging interface 151. Specifically, in an exemplary embodiment of the present disclosure, the output is a Lighting interface. The adapter 3 is provided that the portable power source can be used to charge devices of different interface types. Thus, the application range of the portable power source can be broadened.

Furthermore, referring to FIG. 7, the body 1 further includes a second fixing groove 19 for receiving the adapter 3 therein. Specifically, in an exemplary embodiment of the present disclosure, the second fixing groove 19 is arranged on a bottom wall of the slot 16 for fully receiving the charging interface 151 therein. In this way, it is convenient for users to take and store the adapter 3 to reduce its lost risk. It should be noted that, in other exemplary embodiments of the present disclosure, the second fixing groove 19 can be arranged on other portions of the body 1.

Although the features and elements of the present disclosure are described as embodiments in particular combinations, each feature or element can be used alone or in other various combinations within he principles of the present disclosure to the full extent indicated by the broad general meaning of the terms in which the appended claims are expressed.

What is claimed is:

1. A portable power source comprising:
a body;
a charging member connected to the body and comprising a connecting strip and a plug, an end of the connecting strip connected to the body and the plug formed on an opposite end of the connecting strip; and wherein
the connecting strip is flexible so that it can be used in a bending state or a stretching state.

2. The portable power source as claimed in claim 1, wherein the connecting strip comprises a flexible section and a mounting section, a portion of the flexible section connected to the body and an opposite portion of the flexible section connected to the mounting section, the plug formed on the mounting section, the flexible section and the mounting section integrated with each other by flexible material.

3. The portable power source as claimed in claim 2, wherein the mounting section is thickened with respect to the flexible section along a direction perpendicular to an extension direction of the flexible section.

4. The portable power source as claimed in claim 2, wherein the body comprises a first receiving recess matched with the mounting section.

5. The portable power source as claimed in claim 2, wherein the flexible section comprises at least one thinning, groove arranged along the extension direction of the flexible section.

6. The portable power source as claimed in claim 2, wherein the flexible section is tightly fixed with the body.

7. The portable power source as claimed in claim 1, wherein the body comprises a receptacle for inserting the plug therein.

8. The portable power source as claimed its claim 7, wherein the receptacle and a fixing portion of the connecting strip connected to the body are respectively formed at two opposite sides of the body.

9. The portable power source as claimed in claim 7, wherein the connecting strip is in the bending state when the plug is inserted into the receptacle, and a gap is formed between a bending portion of the connecting strip and the body.

10. The portable power source as claimed in claim 7, wherein the body further comprises a bar arranged on the receptacle for inserting the plug therein by an interference fit way.
